(19) United States
(12) Patent Application Publication
(10) Pub. No.: US 2024/0006738 A1
(43) Pub. Date: Jan. 4, 2024

(54) PANEL FOR VEHICLE WITH HEATING OF EXTERIOR SURFACE OF PANEL

(71) Applicant: SABIC Global Technologies B.V., Bergen op Zoom (NL)

(72) Inventors: Steven Marc Gasworth, Novi, MI (US); Erhard Bruss, Remagen (DE); Ronald van der Wal, Bergen op Zoom (NL)

(21) Appl. No.: 18/037,701

(22) PCT Filed: Oct. 1, 2021
(86) PCT No.: PCT/EP2021/077054

§ 371 Date: May 18, 2023

(30) Foreign Application Priority Data
Nov. 19, 2020 (EP) 20208540.3

(51) Int. Cl. H01Q 1/02; H05B 3/00; H05B 1/02; G01S 7/481; G01S 7/02; B32B 27/08; B32B 27/20; B32B 27/28; B32B 27/40; B32B 3/26

(52) U.S. Cl. CPC H01Q 1/02; H05B 3/0042; H05B 1/0236; G01S 7/4811; G01S 7/027; B32B 27/08; B32B 27/20; B32B 27/283; B32B 27/40; B32B 3/263; H05B 2214/02; B32B 2605/00; B32B 2307/7376; B32B 2307/412; B32B 2307/4026

(57) ABSTRACT

The present disclosure relates to a method and apparatus to control the temperature of an panel of a vehicle, including sensing a vehicle condition, communicating the vehicle condition to a controller, associating the vehicle condition with a temperature control requirement, based on the temperature control requirement, generating a temperature control signal, communicating the temperature control signal to a beam generator; and in association with the control signal generating a beam within a near infrared band of 800 nm to 2000 nm, selected to transmit substantially through a base layer but not an outer layer.

### TECHNICAL FIELD

This document relates generally to automotive panels, and particularly to a panel having a heatable exterior surface and system to selectively heat the heatable exterior surface from behind the panel.

### BACKGROUND

Various driver assistance technologies have emerged to aid a driver and/or an autonomous controller in the control of a vehicle. These systems can use sensors to gather information used to characterize the environment. Various sensors use electromagnetic information. Cameras, radar, laser (including lidar), and other sensors can form a part of a driver assistance system.

Often, such sensors are shielded from the environment with some kind of protective cover. The sensors components themselves can be constructed with a sensor device, e.g. a silicon device, disposed in a housing. Sensor components can be disposed in or behind a further housing, such as a windscreen (i.e. glazing), bumper fascia, or another protective device.

Foreign material accumulation on such protective coverings can undesirably affect performance of the sensor. An illustrative example is when frost covers a window, hampering the ability of an optical device to collect information in the human-visible spectra. Some systems are relatively intolerant of diminished fidelity of sensed information, and thus there is an interest in reducing the impact of foreign material, such as by removing it from the cover.

Heating devices have been developed to assist with this. For example, defrosting can be accomplished using traditional wire gridlines disposed on a protective cover. However, these often interfere with sensing. If the sensor is a camera, the image is diminished because the wires block some information. If the sensor is sensing some other information, such as the amount of reflected laser energy in the case of a lidar sensor, blocking, reflecting or absorbing some of the sensor information with a defroster grid can be undesirable. Other approaches have been used for clearing foreign material, but these suffer from inconvenient packaging, inability to localize effect, and/or low efficiency.

International patent application Publication No. WO/2019/169077 to SABIC demonstrates a transparent panel and a defrosting approach using an edge-mounted radiation source to transmit excitation energy to an emitter to cause the emitter to transmit energy to the foreign material to cause the foreign material to heat itself. This is a clever approach because, by in large, only the foreign material is heated. However, this approach places the exciter undesirably far from the region to be treated in some applications, which can decrease efficiency.

International patent application Publication No. WO/2020/104668A1 to SABIC demonstrates a panel that uses radiation selected to be absorbed by the material through which it travels. This is a simple approach—a heated panel—but it suffers one shortcoming in that the entire thickness of the heated material absorbs energy, which can be inefficient and can delay heating of the exterior surface of the panel.

It is desirable to provide means for addressing foreign material without these shortcomings.

### SUMMARY

The present subject matter, in various embodiments, addresses these shortcomings by providing a stack-up of materials that are specifically selected to absorb energy of a certain wavelength, while allowing others to pass through. Along with these materials, devices capable of projecting energy at certain wavelengths are used, and a controller is provided to control the system.

For example, the outer layer of a stack can absorb energy at a certain wavelength, while a base or inner layer does not, thus only the outer layer can be heated, which provides improved efficiency. One or more of the outer, base or inner layer can be transparent or translucent to a second device that transceives energy at a second wavelength that is not absorbed. If the signals interfere with one another, they can be independently controlled to provide for compatible operation.

### BRIEF DESCRIPTION OF THE DRAWINGS

The drawings illustrate generally, by way of example, various embodiments discussed in the present document. The drawings are for illustrative purposes only and may not be to scale.

FIG. 1 illustrates a perspective view of a panel of an automobile, according to some examples.

FIG. 2 shows a prior art approach to heating foreign material, according to an example.

FIG. 3 shows a cross section taken along the line A-A in FIG. 1, and illustrates a structure applicable to several examples.

FIG. 4 shows a cross section taken along line A-A in FIG. 1, and illustrates an optional structure applicable to several examples.

FIG. 5A shows a close-up of section 5A in FIG. 1, according to some examples.

FIG. 5B shows a cross section taken along line 5B-5B in FIG. 5A, according to some examples.

FIG. 6 illustrates wavelength absorption of several materials.

FIG. 7 illustrates a system including a controller, according to several examples.

FIG. 8 illustrates a method of controlling the temperature of a panel, according to some examples.

### DETAILED DESCRIPTION

The present disclosure provides systems and methods of defrosting, or otherwise clearing, a portion of a vehicle panel so that sensor information can pass through the panel while avoiding unwanted interference. Various examples capitalize on a phenomenon whereby polymers absorb electromagnetic radiation at a greater rate when that radiation is emitted at specific wavelengths. A panel of a vehicle is provided with an outer layer that is selected to absorb electromagnetic radiation of a first wavelength at a certain rate. This outer layer can be disposed over a base layer that absorbs little, if any, of that same electromagnetic radiation. The outer layer can be coated over the base layer, injection molded over that base layer, or formed using some other process. Thus, a heating beam can be projected through a vehicle panel, passing through a base layer essentially without being absorbed, to an outer layer where it is absorbed to generate heat to heat any foreign material disposed thereon. The heating beam's energy is focused, in a sense, primarily onto the outer layer, thus allowing for lower energy consumption and faster heating, as the entire thickness of the panel does not need to be heated. As the thermal mass of the outer layer can be lower, it can also contribute to faster heating. Other options provide for still more efficient use of heating energy, e.g., the heatable outer portion can be limited to a specific target area.

This multi-layer approach can allow for construction of a panel that is comprised of a base layer that is suitably thick and tough for use on an automotive bumper cover, and an outer layer that may be less thick or tough, but that provides desirable energy-absorbing and heat generating properties. Some examples disclosed feature a polyurethane outer layer disposed on a polycarbonate base layer. The heatable outer layer can form a portion of the colored exterior of the vehicle.

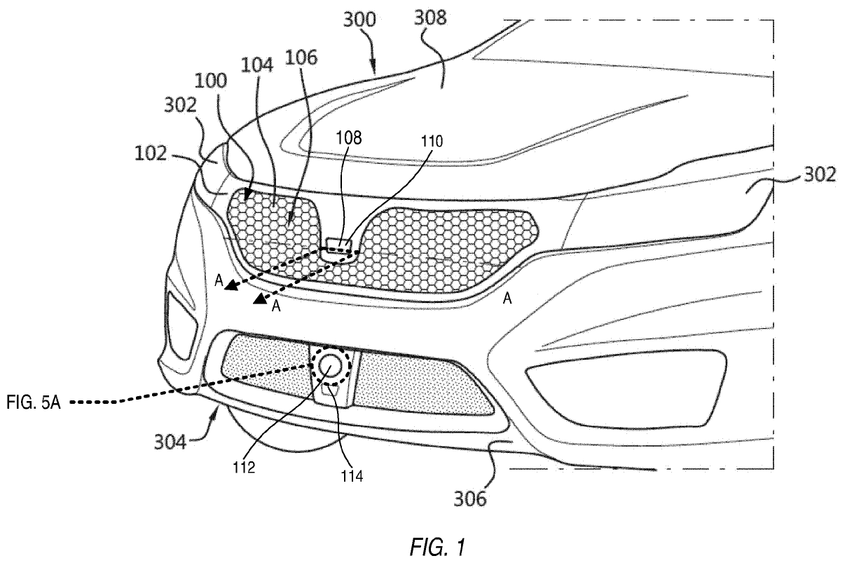

FIG. 1 illustrates a perspective view of a panel of an automobile, according to some examples. A panel assembly 100 can be a front-end panel assembly. The panel assembly 100 can be a flat panel, a glazing, a lens for lighting modules, or another panel. The panel assembly 100 can be used for one or more of defogging, defrosting, deicing, or otherwise removing foreign material. The panel can be used in several applications such as exterior lighting, automotive exterior lighting (e.g. headlights and tail lights), air field lights, street lights, traffic lights, and signal lights; glazings, for example, for transportation (e.g. automotive) or construction applications (e.g. skylights); appliances, for example, for defrosting a refrigerator door, a freezer door, an interior wall of a freezer and/or a refrigerator compartment; for signage, and like applications. Such a panel assembly 100 allows for one or more of defogging, defrosting, and deicing to be accomplished without the use of resistively-heated conductors. The panel assembly 100 can be used for heated surfaces such as mirrors (such as mirrors located in a bathroom, a fitness facility, a pool facility, and a locker room), floors, doors (such as refrigerator doors and freezer door), shelves, countertops, and the like. When the heated surface is a mirror, the mirror can be “silvered” on a surface of a layer other than the outer layer.

The panel assembly 100 can be a panel on a vehicle, for example, a front panel or a rear panel having a sensor disposed on an internal (car side) surface. The panel assembly 100 can be a bumper having a sensor. The sensor can be a lidar sensor. The sensor can help with autonomous driving of the vehicle. The sensor can detect objects proximal to the vehicle. The sensor can detect the level of ambient light.

The panel assembly 100 can be provided as a component of a front fascia 304 of a vehicle 300. The panel assembly 100 can be provided as a stand-alone component attached the front end of a vehicle 300. The panel assembly can be located between a pair of headlights 302 disposed at its sides. A hood 308 of the vehicle can be located proximal the top of the panel assembly 100. A bumper assembly 306 can be provided near the bottom of the panel assembly 100. The panel assembly may be formed of polymers, such as thermoplastic and/or thermoset materials.

Various devices can be affixed to the vehicle behind one or more portions 110, 112, 114 of the panel assembly 100, in particular safety devices such as cameras, lidar, radar or various other transducers. Additionally, a radiation source to heat these portions can be affixed to the panel assembly 100 and/or the vehicle. As set forth above and elsewhere in this disclosure, one or more of these radiation sources can emit energy that is primarily absorbed in a selected region, such as an outer region of the panel assembly, to heat it.

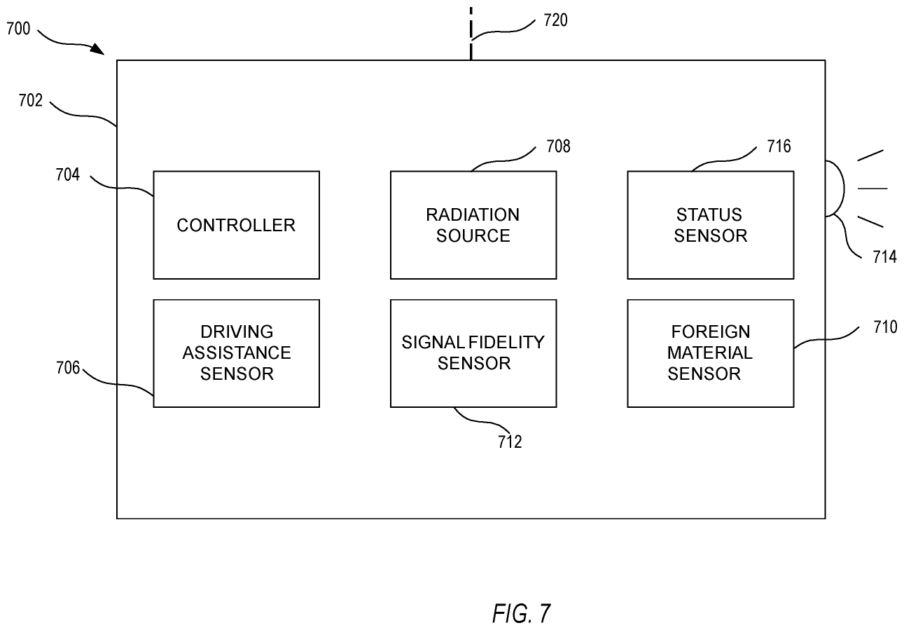

The panel assembly 100 can include an accent panel 104. The accent panel 104 can be inserted into opening 106 and can comprise a grille, or can be a panel occupying the space traditionally reserved for grilles. The accent panel 104 can form a solid, or nearly solid, panel useful for stylizing the panel assembly 100. The accent panel 104 can include lights or can be illuminated. Devices, including one or more of those described in relation to FIG. 7, as well as other devices, can be integrated with an accent panel 104, such as via integration as part of a panel assembly including various components such as structure and electronics (i.e. a “smart panel”). While the heating is useful for clearing a signal path for a sensor, it can be used for other things, such as clearing foreign material from a logo, indicator, or another component of a smart panel.

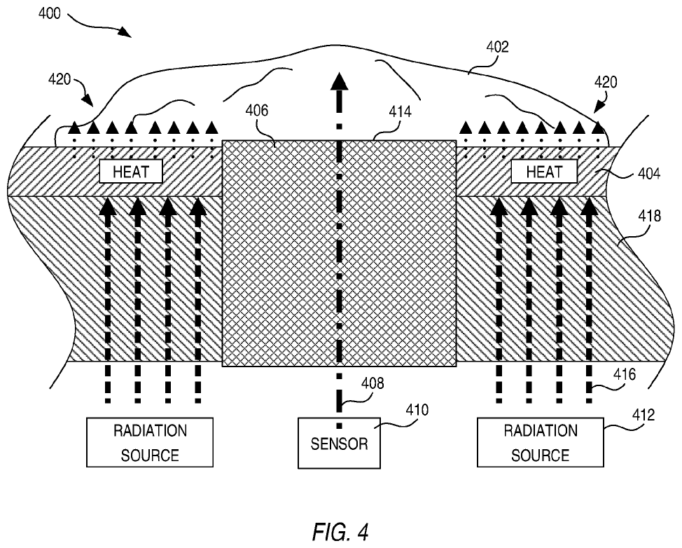

The panel assembly 100 can define a sheet 108. The sheet can be formed into a monolithic part with other portions of the panel assembly 100, such as an accent panel 104, a frame 102, or other pieces, or can comprise a discreet molded part fastened to the panel assembly 100, as is discussed in more detail in relation to FIG. 4. The sensors disclosed herein can be aligned with the sheet 108. The sheet can be formed of selected polymers to compliment to function of the sensor, and/or a radiation source to heat the sheet 108.

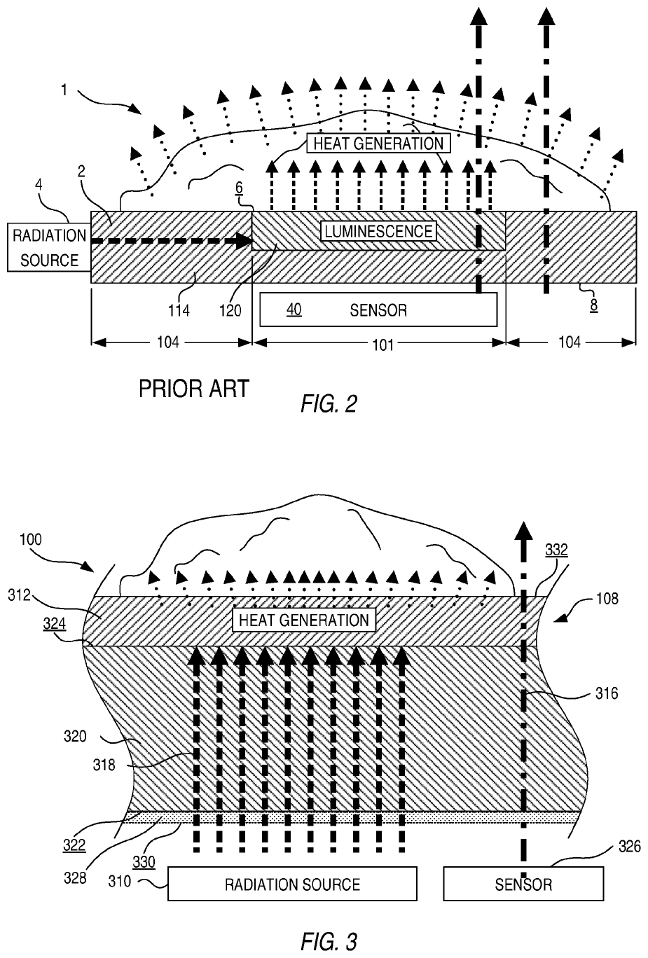

FIG. 2 shows a prior art approach to heating foreign material, according to International Patent Application Publication No. WO/2019/169077 to SABIC. The illustrated apparatus is useful for defrosting transparent panels (e.g., windows or glazing). In such a panel, a radiation source 4 is not placed behind the transparent panel, so as to provide an unobstructed view, and thus the radiation source is placed on the edge of the layer 2 of the window/glazing 1. One or both of radiation or heat is emitted from an emitting agent at least through first surface 6 in emitting area 101. The emitting agent can comprise one or both of a luminescent agent and an absorber. This approach relies on special additive materials, emitters or absorbers, to be placed in the localized heating area, along with an edge-mounted radiation source, and does not utilize the innate ability of selected materials to absorb a selected heating wavelength to generate heat.

Sensor 40 can be located opposite of surface localized emitting region 120. The sensor can be a light detection and ranging (i.e. lidar) sensor. For lidar applications, the emitting agent can comprise a luminescent agent that does not absorb or emit at the lidar wavelengths, and thus does not interfere with the lidar unfavorably.

In the device, light (including infrared light) from the radiation source propagates by total internal reflection (TIR) in the non-emitting region 114 to the emitting region 120. When the emitting agent comprises a luminescent agent, photons that encounter the luminescent agent can be absorbed and re-emitted from the luminescent agent into a so-called escape cone to be emitted from a broad surface of the device. That is, the luminescent agent can serve in part to deflect light from TIR, a state of confinement within the device, to a broad surface, from which the light can escape and be absorbed by water (for example, liquid water or ice) on the surface of the device thereby heating the water. Because this deflection results from light interaction with the luminescent agent, it occurs primarily in the emitting region where the luminescent agent is concentrated. When the emitting agent comprises an absorber, photons that encounter the absorber can be absorbed and the absorber can emit heat. The emitting device can heat the surface by heating the emitting layer and conducting heat to the surface, thereby heating the surface, or it can heat the surface by radiation. In either case of the luminescent agent or the absorber, power from the edge-coupled source is thereby projected to the emitting region, enabling at least one of defrosting, deicing, or defogging in that region.

One shortcoming of FIG. 2 is that it requires edge coupling of a radiation source. If the panel is a large part, such as a fascia, the energy must travel a long distance before encountering an emitting region 120. This can be undesirably inefficient. Another shortcoming of the approach of FIG. 2 is that the emitting region 120 must include an emitter or an absorber. Such materials can interfere with the effectiveness of a sensor 40. Further, they can be too expensive to be used practically in the automotive market.

International patent application Publication No. WO/2020/104668A1 to SABIC follows a different approach by bulk heating the panel material, which provides for closer location of the radiation source to the area to be defrosted (e.g., the area directly in front of a sensor such as a lidar sensor). This approach can benefit from less expensive materials. However, the approach requires bulk heating, which can consume an undesirable amount of power, and which can take additional time as the bulk material inevitably conducts heat to locales that do not need to be heated. For example, the backside of the panel may not need to be heated.

FIG. 3 shows claimed subject matter via a cross-section taken along the line A-A in FIG. 1, and illustrates the structure applicable to several examples. The subject matter is not limited to the section A-A in FIG. 1 and can be used elsewhere, but this section is useful to illustrate certain aspects. A panel assembly 100 for a vehicle can function to transmit a sensor beam 316. The sensor beam 316 can be formed of transceived sensing energy, e.g. lidar, at a sensing wavelength. The panel assembly 100 can also be for absorbing heating energy, which can be in the form of an electromagnetic beam 318. The heating beam 318 can take various modes, e.g. laser or infrared, having a selected wavelength. A heating wavelength can be other than a sensing wavelength.

A base layer 320 can define a base inner major surface 322 and a base outer major surface 324. An outer layer 312 can be formed onto the base outer major surface 324 of the base layer 320. The base layer 320 can be formed of a base layer polymer selected to transmit a heating wavelength band (A) within a near infrared band 800 nm to 2000 nm at a transmission rate of one or more of the group comprising: equal to or greater than 40% when the base layer thickness is 3 mm; equal to or greater than 50% when the base layer thickness is 2 mm; and equal to or greater than 60% when the base layer thickness is 1 mm. The outer layer 312 can be formed of an outer layer polymer selected to transmit the heating wavelength band (A) a transmission rate of one or more of the group comprising: equal to or less than 60% when the base layer thickness is 4.0 mm; and equal to or less than 50% when the base layer thickness is 5.4 mm.

The base layer 320 may comprise any number of materials including, but not limited to, polycarbonate (such as a bisphenol A polycarbonate), polystyrene, a polyester (such as poly(ethylene terephthalate) and poly(butyl terephthalate)), a polyarylate, a phenoxy resin, a polyamide, a polysiloxane (such as poly(dimethyl siloxane)), a polyacrylic (such as a polyalkylmethacylate (e.g., poly(methyl methacrylate) (“PMMA”)) and polymethacrylate), a polyimide, poly(ether)imide, a vinyl polymer, an ethylene-vinyl acetate copolymer, a vinyl chloride-vinyl acetate copolymer, or a polyurethane (“PUR”). The base layer 320 can comprise at least one of polyvinyl chloride, polyethylene, polypropylene, polyvinyl alcohol, poly vinyl acrylate, poly vinyl methacrylate, polyvinylidene chloride, polyacrylonitrile, polybutadiene, polystyrene, polyvinyl butyral (“PVB”), or polyvinyl formal. The base layer can comprise one or more of the foregoing polymers. The base layer can comprise a copolymer comprising one or more of the foregoing polymers.

The outer layer 312 can be formed from one of: polycarbonate; polypropylene compound; PMMA; PVB; and PUR. More specifically, the outer layer 312 may comprise at least one of the following material: polycarbonate with a lowest near IR transmission at about 1675 nm, polypropylene compound with a lowest near IR transmission at about 1730 nm, PMMA with a lowest near IR transmission at about 1760 nm, PVB with a lowest near IR transmission at about 1800 nm, or/and PUR with a lowest near IR transmission at about 1719 nm. The outer layer composition can comprise an adhesion promoter.

At least one of the base layer 320 and the outer layer 312 can be at least one of lidar-transparent and radar-transparent. In some examples, both the base layer 320 and the outer layer 312 are lidar-transparent and radar-transparent. The outer layer 312 can include a pigment that at least partially reflects visible light. The outer layer 312 can be coated by a material including a pigment that at least partially reflects visible light.

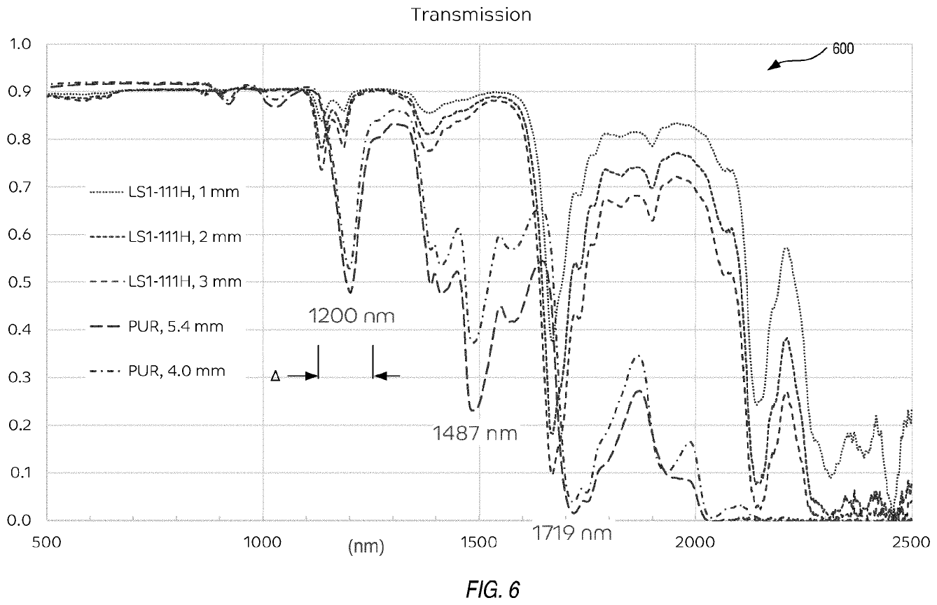

The heating beam 318 can be generated by the radiation source 310. The radiation source 310 can produce wavelength(s) within the specific wavelength band (A) of the thermoplastic material. More preferentially, the radiation source 310 can produce only wavelength(s) within the specific wavelength band (A) of the thermoplastic material. The wavelength can be narrowly tailored to absorption characteristics of the outer layer 312. This phenomenon is illustrated in FIG. 6. A number of thermoplastic materials, such as polycarbonate, poly(ether)imide, polystyrene, polyester and acrylates, tend to absorb infrared wavelengths at a greater rate starting at 1600 nm and higher. Some absorption is up to 90% for certain wavelengths. The absorption curve for each thermoplastic has its own characteristics, but in general, the transmission of electromagnetic radiation drops for such materials at wavelengths above 1600 nm. As illustrated, polyurethane materials (at 4.0 mm and 5.4 mm thickness), energy can be absorbed at a greater rate at 1200 nm, 1487 nm, 1719 nm, or other illustrated minima. Minima for polycarbonate (LS1-111H 1 mm; LS1-111H 2 mm; LS1-111H 3 mm, available from SABIC) include 1130 nm, 1190 nm, 1380 nm, and particularly 1675 nm. Other minima include 1900 nm, 2150 nm, and others as illustrated in FIG. 6. It should be noted that other materials demonstrate similar phenomena, such as certain polypropylenes which demonstrate minima at 1200 nm, 1400 nm and 1750 nm. These materials include 108MF, 595A, 8102 and 8122 from SABIC. PMMA has a minima of interest at 1200 nm. UV Acrylic has a minima of interest at 1150 nm and 1660 nm.

The radiation source 310 can emit radiation with a wavelength of 100 to 2,500 nm. The radiation source can emit radiation with a wavelength of 300 to 1,800 nm. The radiation source can emit near infrared radiation with a wavelength of 700 to 1,500 nm. The radiation source can emit near infrared radiation with a wavelength of 800 to 1,200 nm. The radiation source 310 can emit radiation having a wavelength in the range of equal to or more than 800 nm, preferably a wavelength in the range of more than 1000 nm and/or more than 1600 nm and/or more than 1800 nm. Preferably, the radiation can have an intensity maximum in the wavelength range of 1100 nm to 1300 nm and/or in the wavelength range of 1400 nm to 1600 nm and/or in the wavelength range of 1600 nm to 1800 nm. The radiation source can emit at a wavelength of approximately 1190-1210 nm, 1480-1500 nm or 1710-1730 nm. The emitted radiation from the radiation source can be filtered to a desired wavelength before being introduced to the base layer.

The radiation source can be, for example, a laser diode, a light-emitting diode (LED), a light bulb (such as a tungsten filament bulb); an ultraviolet light; a fluorescent lamp (such as one that emits white, pink, black, blue, or black light blue (BLB) light); an incandescent lamp; a high intensity discharge lamp (such as a metal halide lamp); a cold-cathode tube, fiber optical waveguides; organic light-emitting diodes (OLED); or devices generating electro-luminescence (EL).

The sensor beam 316 can be generated by a sensor 326. The panel system can include a lidar transceiver disposed in suitable relationship to or coupled to the panel opposite the outer layer, the lidar transceiver configured to transceive lidar energy through the thickness of the panel through the base layer to the outer layer. As used herein, the term “coupled” should not be limited to the term “abutting” and can accommodate various intermediate fasteners and structure, for example a case of a transceiver can be supported by a vehicle, and not directly by a panel. The lidar can broadcast a lidar beam at a different or other wavelength than the heating wavelength. The lidar wavelength can be a 905 nm or a 1550 nm lidar wavelength. The sensor beam can be in the range of 900 nm to 1100 nm, 1100 nm to 1300 nm, 1300 nm to 1400 nm, 1400 nm to 1600 nm, or 1600 nm to 1800 nm.

In some examples, an optional inner layer 328 can define an inner surface 330 of the panel assembly 100 that can be cleared of foreign material such as ice or water by the radiation source 310. The inner layer 328 can be formed of a material other than the outer layer 312 and the base layer 320. The outer layer 312 and the inner layer 328 can be formed by the same material. The layers can be molded onto one another, such as by overmolding. In an example, a system can detect whether foreign material have collected or formed onto one or both of the inner layer 328 and the outer layer 312. A system capable of this is discussed in relation to FIG. 7.

The outer layer can be formed by injection molding. For example, the injection molding can comprise injection of a base layer material composition, for example, from a first nozzle into a mold. In examples disclosed herein, flow through a first nozzle can be discontinued before flow through a second nozzle begins. In sequence with the flow through the first nozzle being discontinued, a mold can be open a specified amount that correlates with a desired thickness of the outer layer, to provide for in-mold coating, such as through the second nozzle. The mold can be opened to provide for PUR flooding, such as through the second nozzle. The process can include in-mold coating and/or PUR flooding. A sheet, such as sheet 108, can be formed as a one-shot (1K), or two-shot (2K) molded sheet, depending on the application and functionality of the assembly. The outer layer 312 can be overmolded onto the base layer 320. The outer layer 312 can be a wrap or paint. The outer layer 312 and the base layer 320 can form a part of a monolithic layer. The outer layer can include an infusion of the monolithic layer. The sheet may comprise an uncoated single sheet of thermoplastic materials or a laminate with one or more layers on a substrate, such as a thermoplastic substrate with a protective coating or layer, or a co-extruded sheet comprising two or more co-extruded layers, or a combination thereof.

Several features that address shortcomings associated with FIG. 2 are set forth. For example, a radiation source 310 can be placed closer to the area to be heated. Rather than follow the emitter or absorber approach of FIG. 2, the present subject matter can transmit heating energy to be absorbed by the outer layer 312, thus heating that layer primarily or exclusively. Rather than rely on additives to emit or absorb heating energy, examples can rely on the inherent ability of the panel material to absorb limited wavelengths, although some embodiments can implement additives to achieve the desired function. In some examples, materials can be selected such that a 2-shot injection molded part is provided with an outer layer 312 selected to absorb heating energy overmolded over a base layer 320 selected to absorb none or a desirably small portion of heating energy. The radiation source 310 can use a less powerful emitter than ones with a larger wavelength range and therefore can provide more heating with less energy than prior art approaches. The present subject matter is not so limited, though, and can include agents or additives that can absorb or be excited by radiation from the radiation sources. These can include radiationless absorbers and/or luminescent species. The former can convert absorbed radiation to local heating. The latter can generate heat due to imperfect quantum yield and to Stokes shift, and re-emit radiation in a narrow band. Combinations of innate absorption, added absorbers, and added luminescent species can be used. Examples of absorbers can include, but are not limited to, lanthanum hexaboride (LaB₆), cesium tungsten oxide (CWO), antimony-doped tin oxide (ATO), indium-doped tin oxide (ITO). Each of these absorbers, but for ITO, can be added to polycarbonate. ITO can be added to a silicone hardcoat as disclosed in U.S. Pat. No. 9,862,842 (SABIC). Additional absorbers include Lumogen IR 765 and Lumogen IR 788. Lumogen is a trademark of BASF.

Using the property of absorption of infrared radiation allows the sheet to increase in temperature and speed up the de-fogging and/or de-icing, thus creating an improved solution for energy efficient, desirably fast, optionally homogeneous (i.e. uniform), and optionally invisible de-fogging/defrosting/de-icing of panel assemblies. The absorption of infrared radiation can apply to optically transparent, translucent, and opaque thermoplastics.

Optionally, the outer layer, or an insert as discussed in relation to FIG. 4, can be formed of a thermoplastic material that includes scattering particles. Examples are disclosed in U.S. Pat. No. 9,168,696 to SABIC. The outer layer can include a laser-marked UV stabilizer defining a faint mark, with minimal change in topography, in the outer layer to scatter the heating wavelength. The laser beam can have a wavelength less than or equal to 500 nanometers. The mark can result from increasing the reflectivity of a thermoplastic material. The thermoplastic material can have an initial L* value, and wherein the mark can have an increase in L* value of greater than or equal to 20 compared to the initial L* value. The substrate can include a composition comprising the thermoplastic material capable of absorbing light having a wavelength of less than or equal to 500 nanometers. The thermoplastic material, in the form a plaque having a thickness of 1 millimeter, can have a visible transmission of greater than 70% as measured according to ASTM D1003-00 using D65 illumination and 10 degrees observer. The composition can include an ultraviolet absorbing additive capable of absorbing light having a wavelength of less than or equal to 500 nanometers. The ultraviolet absorbing additive can be selected from hydroxybenzophenones, hydroxybenzotriazoles, hydroxybenzotriazines, cyanoacrylates, oxanilides, benzoxazinones, benzylidene malonates, hindered amine light stabilizers, nano-scale inorganics, or a combination comprising at least one of the foregoing. The substrate can have a maximum reflection in the visible spectrum represented by the initial L* value of less than 25 when measured with a black background according to ASTM E308-08 and CIELAB 1976. The initial L* value can be less than 20. The substrate can be un-pigmented. The mark can be a watermark. The watermark can have a profile height of less than 15 micrometers. The profile height can be less than 10 micrometers. The mark can be a light colored mark. The light colored mark can have a profile height of less than 35 micrometers. The profile height can be less than 30 micrometers. The composition can be colored. The mark can be a white mark. The composition can be inscribed with a laser beam having a wavelength greater than 500 nanometers to achieve a dark mark. The visible transmission can be greater than 75%. The visible transmission can be greater than 80%. The composition can include a material selected from the group consisting of polycarbonate, polycarbonate copolymers, polyester, polymethyl methacrylate, polystyrene, polyamide, polyolefin, polyvinyl chloride, polyimide, polyetherimide, polylactic acid, and combinations comprising at least one of the foregoing. The increase in L* value can be greater than or equal to 25 compared to the initial L* value. The mark can include individual laser inscribed dots having a diameter of less than or equal to 80 micrometers. The diameter can be less than or equal to 60 micrometers. The diameter can be less than or equal to 40 micrometers. The composition can be colored.

A method for generating a mark on an article can include bonding a first component to a second component with a laser beam having a wavelength of greater than or equal to 800 nanometers. The first component can include a non-reflective thermoplastic material that can absorb light having a wavelength of less than or equal to 500 nanometers, and wherein the thermoplastic material can have an initial L*. The second component can include a thermoplastic material that can absorb light having a wavelength of greater than or equal to 800 nanometers. The method can include contacting the first component with a second laser beam having a wavelength less than or equal to 500 nanometers to generate a mark. The mark can result from increasing the reflectivity of the non-reflective thermoplastic material. The mark can have an increase in L* of greater than or equal to 20 compared to the initial L*.

A thermoplastic material so marked, in the form a plaque having a thickness of 1 millimeter, can have a percent transmission of less than or equal to 9% at the laser wavelength as measured according to ASTM D 1003-00 using D65 illumination and 10 degrees observer. The substrate can include a composition comprising the thermoplastic material capable of absorbing light having a wavelength of less than or equal to 500 nanometers. The thermoplastic material, in the form a plaque having a thickness of 1 millimeter, can have a visible transmission of greater than 70% as measured according to ASTM D 1003-00 using D65 illumination and 10 degrees observer. The percent transmission can be less than or equal to 4%. The mark can have a mark L* value measured from a back side of the substrate of greater than or equal to 46, and a delta L* value of less than or equal to 10. The delta L* value can be the difference in the mark L* value measured from the front side and the mark L* value measured from the back side.

Optionally, the panel assembly 100 can include a hardcoat layer on an outer layer surface 332. The hardcoat layer may comprise at least one of a silicone, a polyurethane, an acrylate, and a metal oxide. The sheet is translucent, preferably transparent, to electromagnetic radiation in at least one of the ranges for radio frequency radiation, infrared radiation, visible light and ultraviolet radiation. For example, the sheet may be optically transparent, i.e. transparent to visible light, and be translucent for at least one of radio frequency radiation, infrared radiation and ultraviolet radiation. Other combinations of translucency and/or transparency for at least two types of electromagnetic radiation are possible as well.

The panel assembly 100 can comprise a protective layer defining the outer layer surface 332. The protective layer can comprise at least one of a UV protective layer, an abrasion resistant layer, or an anti-fog layer. The protective layer can comprise a silicone hardcoat.

A UV protective layer can be applied to an external surface of the device. The UV protective layer can be applied by various means, including dipping the plastic substrate in a coating solution at room temperature and atmospheric pressure (i.e., dip coating). The UV protective layer can also be applied by other methods including, but not limited to, flow coating, curtain coating, and spray coating. For example, the UV protective layer can be a coating having a thickness of less than or equal to 100 micrometers (μm). The UV protective layer can be a coating having a thickness of 4 to 65 micrometers. The UV protective layer can include silicones (e.g., a silicone hard coat), polyurethanes (e.g., polyurethane acrylate), acrylics, polyacrylate (e.g., polymethacrylate, polymethylmethacrylate), polyvinylidene fluoride, polyesters, epoxies, and combinations comprising at least one of the foregoing. The UV protective layer can comprise a UV blocking polymer, such as at least one of poly(methyl methacrylate) or polyurethane. Examples are disclosed in European Patent No. EP1879739B1 at paragraphs 0042 and 0045, both to SABIC. The UV protective layer can comprise a UV absorbing molecule. The UV protective layer can include a silicone hardcoat layer (for example, AS4000, AS4700, or PHC587, commercially available from Momentive Performance Materials).

The UV absorbing molecule can comprise at least one of a hydroxybenzophenone (e.g., 2-hydroxy-4-n-octoxy benzophenone), a hydroxybenzotriazine, a cyanoacrylate, an oxanilide, a benzoxazinone (e.g., 2,2′-(1,4-phenylene)bis(4H-3,1-benzoxazin-4-1), commercially available under the trade name CYASORB UV-3638 from Cytec), an aryl salicylate, or a hydroxybenzotriazole (e.g., 2-(2-hydroxy-5-methylphenyl)benzotriazole, 2-(2-hydroxy-5-tert-octylphenyl)benzotriazole, or 2-(2H-benzotriazol-2-yl)-4-(1,1,3,3-tetramethylbutyl)-phenol, commercially available under the trade name CYASORB 5411 from Cytec). The UV absorbing molecule can comprise at least one of a hydroxyphenylthazine, a hydroxylphenylbenzothazole, a hydroxyphenyltriazine, a polyaroylresorcinol, or a cyanoacrylate. The UV absorbing molecule can be present in an amount of 0.01 to 1 wt %, specifically, 0.1 to 0.5 wt %, and more specifically, 0.15 to 0.4 wt %, based upon the total weight of polymer in the respective region.

The UV protective layer can include a primer layer and a coating (e.g., a top coat). A primer layer can aid in adhesion of the UV protective layer to the device. The primer layer can include, but is not limited to, acrylics, polyesters, epoxies, and combinations comprising at least one of the foregoing. The primer layer can also include ultraviolet absorbers in addition to or in place of those in the top coat of the UV protective layer. For example, the primer layer can include an acrylic primer (for example, SHP401 or SHP470, commercially available from Momentive Performance Materials).

An abrasion resistant layer (e.g., a coating or plasma coating) can be applied to one or more surfaces of the device. For example, an abrasion resistant layer can be located on (for example, directly on) one or both of the outer layer surface 332 and an inner surface 330 of the device or a second protective layer, such as a UV protective layer, can be located in between. The abrasion resistant layer can include a single layer or a multitude of layers and can add enhanced functionality by improving abrasion resistance of the device. Generally, the abrasion resistant layer can include an organic coating and/or an inorganic coating such as one or more of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon carbide, silicon oxy carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, or glass.

The abrasion resistant layer can be applied by various deposition techniques such as vacuum assisted deposition processes and atmospheric coating processes. For example, vacuum assisted deposition processes can include, but are not limited to, plasma enhanced chemical vapor deposition (PECVD), arc-PECVD, expanding thermal plasma PECVD, ion assisted plasma deposition, magnetron sputtering, electron beam evaporation, or ion beam sputtering.

Optionally, one or more of the layers (e.g., UV protective layer and/or abrasion resistant layer and/or an anti-fog layer) can be a film applied to an external surface of the device by a method such as lamination or film insert molding. In this case, the functional layer(s) or coating(s) could be applied to the film and/or to the side of the device opposite the side with the film. For example, a co-extruded film, an extrusion coated, a roller-coated, or an extrusion-laminated film comprising greater than one layer can be used as an alternative to a hard coat (e.g., a silicone hard coat) as previously described. The film can contain an additive or copolymer to promote adhesion of the UV protective layer (i.e., the film) to an abrasion resistant layer, and/or can itself include a weatherable material such as an acrylic (e.g., polymethylmethacrylates), fluoropolymer (e.g., polyvinylidene fluoride, polyvinyl fluoride), etc., and/or can block transmission of ultraviolet radiation sufficiently to protect the underlying substrate; and/or can be suitable for film insert molding (FIM) (in-mold decoration (IMD)), extrusion, or lamination processing of a three dimensional shaped panel. Examples are disclosed in European Patent No. EP1879739B1 at paragraph 0045, both to SABIC.

One or more of the layers can each independently include an additive. The additive can include at least one of colorant(s) (such as tinting agent(s)), antioxidant(s), surfactant(s), plasticizer(s), infrared radiation absorber(s), antistatic agent(s), antibacterial(s), flow additive(s), dispersant(s), compatibilizer(s), cure catalyst(s), UV absorbing molecule(s) such as at least one of those described above, or adhesion promoter(s) (for example, those disclosed in U.S. Patent Application 2016/0222179). The type and amounts of any additives added to the various layers depends on the desired performance and end use of the panel.

The protective coating(s) can be selected such that it does not absorb in the near-IR range. The protective layer can have a lower refractive index than the one or more layers onto which it is disposed.

The outer layer can be formed by selectively surface infusing the outer agent and optionally an adhesion promoter on a surface of a substrate to form the outer layer. An outer composition can be heated to a fluid infusion temperature prior to being contacted with the surface, as heating to the fluid infusion temperature can facilitate infusion of an outer agent into the base layer material upon contact. The fluid infusion temperature can be greater than or equal to the melting temperature of the outer agent. The surface can be heated to a surface infusion temperature prior to the outer composition being contacted with the surface, as heating to the surface infusion temperature can facilitate infusion of the outer agent into the base layer material upon contact. The contacted surface can be heated to an infusion temperature to allow for the infusion of the outer agent into the base layer material. The fluid infusion temperature, the surface infusion temperature, and the infusion temperature can each independently be 30 to 100° C., or 90 to 100° C.

The outer composition can consist essentially of the outer agent. For example, the outer composition can be free of a solvent that dissolves the base layer material. The outer composition can comprise the outer agent and a liquid. The outer composition can comprise 5 to 100 wt % of the outer agent based on the total weight of the outer composition. The liquid can comprise a solvent that can allow for at least a surface portion of the base layer material to at least partially dissolve, thereby facilitating infusion of the outer agent into the base layer material. The solvent can comprise an organic solvent. The organic solvent can comprise at least one of ethylene glycol butyl ether, diethylene glycol ethylether, diethylene glycol butylether, propylene glycol propylether, dipropylene glycol propylether, tripropylene glycol propylether, or diethylene glycol. The liquid can comprise water.

The selective surface infusing can comprise first masking a surface area of the substrate where the outer agent is not desired. The masking can comprise putting a contact mask, for example, via an adhesive layer onto a surface of the substrate. The contact mask has the benefit of reducing the ability of the outer composition from contacting regions where infusion of the agent into the substrate is not desired. An outer composition can then be contacted with the surface of at least the unmasked area, for example, by at least one of dip coating, flow coating, or spray coating.

The masking can comprise putting a non-contact mask over a surface of the substrate such that the non-contact mask does not come into contact with the surface, thereby reducing the risk of scratching the surface or leaving an adhesive residue. When a non-contact mask is used, the outer composition can be contacted with the surface of at least the unmasked area by spray coating, for example, by spraying the outer composition up at the surface of the outer layer that is oriented horizontal to the ground, thereby reducing run off of the outer composition into masked regions. An atomizing nozzle can be used to spray the outer composition onto the surface.

The selective surface infusing can comprise selectively spraying the outer composition onto the surface in only the outer area. By selectively spraying the outer composition, the use of a mask can be avoided.

The selective surface infusing can comprise contacting the outer composition with a selectively heated surface such that only the area where infusion is desired is heated. For example, the surface can be selectively heated prior to or during contacting with the outer composition. Conversely, or in addition, the surface can be selectively heated after the contacting to promote infusion only in the heated regions. The surface can be selectively heated, for example, by using local heating elements (such as infrared radiation sources) located proximal to a second surface such that the heat transmits through the outer layer to the contacted first surface.

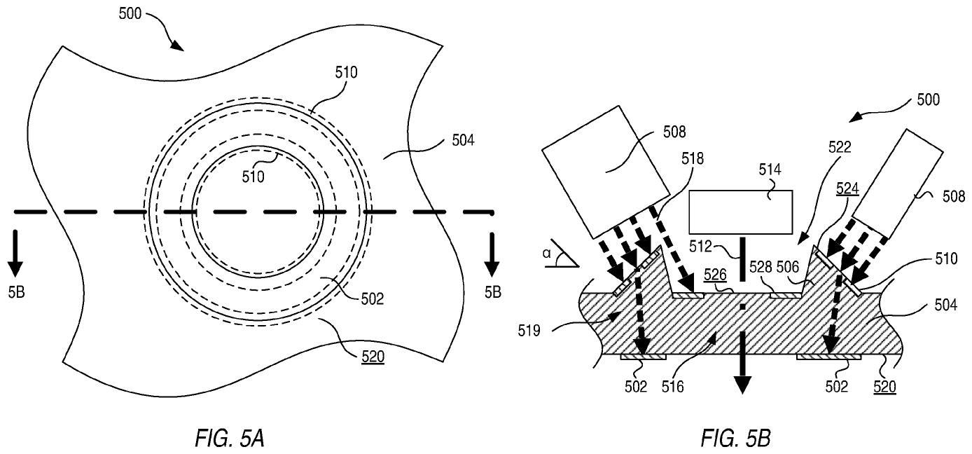

The selective contacting method can be used to contact both the first and second surfaces in one or more contacting steps. When both the first and second surfaces are contacted, the locations of the respective outer regions or layers can correspond to each other, for example, as illustrated in FIG. 5, or can be located independently from each other.

If the contacting comprises spray coating, the spray coating can comprise spray coating the outer composition at a temperature of 30 to 100° C., or 90 to 100° C. and at a pressure of 5 to 50 pounds per square inch (psi), or 15 to 25 psi. The spray coating nozzle can be located 4 to 8 inches (10 to 20 cm) from the surface during the contacting.

The outer layer can be formed via film insert molding. For example, a substrate comprising a base layer material can be molded onto a film comprising an outer region and a non-outer region to form the outer layer. The outer region in the film can be formed via one or more of the above-described methods.

The outer layer can be formed via laminating. For example, a substrate layer comprising a base layer material can be laminated onto a film comprising an outer region and a non-outer region to form the outer layer. The outer region in the film can be formed via one or more of the above-described methods.

FIG. 4 shows a cross section taken along line A-A in FIG. 1, and illustrates an optional structure applicable to several examples. Foreign material 402, such as water or ice, can be removed via the heating of the outer layer 404 with a radiation source 412 via heat beam 416. The panel 400 can include an insert 406 extending through and overmolded by the panel. The insert 406 can be formed of a thermoplastic material that is translucent or transparent to the sensor signal 408 from the sensor 410. The insert can be coated with a protective layer 414 that is an UV protective layer and/or abrasion resistant layer and/or an anti-fog layer as described herein. The insert 406 can include a pigment that at least partially reflects visible light. The insert 406 can be coated by a material including a pigment that at least partially reflects visible light.

One reason to use an insert is that in certain systems, the sensor signal 408 may be undesirably absorbed by the material of the outer layer 404 when that material is selected to absorb heat energy from a heating beam 416 from the radiation source 412. As such, an insert, which is transparent to the sensor signal 408, can be used, even if it's also translucent or transparent to the heat beam 416. By heating material 420 surrounding the insert 406, the insert can be heated by conduction. Further, the foreign material 402 may fall away from the panel 400 if heated only by the outer layer 404, as it will no longer adhere to the outer layer, 404, or a difference in thermal expansion between the outer layer 404 and the insert 406 will cause enough stress to break the bond between the foreign material 402 and the insert 406. The heating beam 416 can be substantially focused on a perimeter (e.g. material 420) of the insert 406.

The insert may be separate from the base layer and outer layer. The insert 406 can be formed of the same thermoplastic material as one of the first thermoplastic material and the second thermoplastic material. Thus, in some molding operations, a strong bond can be formed between the insert 406 and one or both the outer layer 404 and the base layer 418.

FIG. 5A shows a close-up of section 5A in FIG. 1, according to some examples. FIG. 5B shows a cross section taken along line 5B-5B in FIG. 5A, according to some examples. An outer layer 502 can be disposed on a base layer 504 of a panel 500. As described in relation to other embodiments herein, a sensor 514 can be configured to project a sensor beam 512 through a base layer 504. The base layer can be translucent or transparent to the sensor beam, although the same may not be true for visible light in examples, where the sensor beam resides in other spectral ranges. Radiation source 508 can be aligned to the panel 500 to project heating beams to one or both an outer layer 502 and an inner layer 510 to heat them. As discussed herein, in some embodiments the outer layer 502 and/or the inner layer material and a wavelength of the heating beams 518 can be selected such that the material of the inner layer 510 and/or outer layer 502 absorb a significant portion of the energy of the heating beams. As discussed herein, the base layer 504 material and a wavelength of the heating beams can be selected such that the base layer does not absorb a significant portion of the heating beam energy. The radiation sources 508 can operate at different wavelengths to heat two or more different materials. These radiation sources can be independently controlled. Thus, the inner layer 510 can be heated independent of the outer layer 502.

The outer layer 502 need not be co-extensive with the base layer 504. In some examples, the radiation sources 508 can project heating beams 518 that can heat both the inner layer 510 and the outer layer 502 concurrently. As illustrated in some embodiments, the inner layer 510 defines an aperture through which a portion of the heating beams 518 can travel. The heating beams can travel through the base layer 504 to the outer layer, so a portion of the heating beam energy can be to heat the inner layer 510 and at least a portion of a remainder can be to heat the outer layer 502.

The base layer can define a prism 506 extending away from the outer layer. The radiation source 508 can be aligned to the prism to direct the heating energy non-normal to the exterior surface of the outer layer. The prism can be shaped to redirect the heating energy to the outer layer proximal to a path of sensor energy, such as a lidar beam, extending through the panel, such that the radiation source can be positioned lateral to the lidar emitter. An inner layer 510 may optionally be heated by the heating beam 512 as well, such as to control condensation on a surface of the inner layer 510. Optionally, a second inner layer 528 can be disposed on or formed within the recess. In the illustration, the second inner layer 528 formed as part of the inner surface 526, but the present subject matter is not so limited, as the second inner layer 528 can be formed onto the inner surface 526. The second inner layer 528 can be formed of a material to absorb a heating beam, such as heating beam 518. The sensor beam 512 can be adjusted to broadcast at a wavelength selected to heat the second inner layer 528 in a heating mode, and then adjusted to a sensing mode, as disclosed herein. The second inner layer 528 can remove condensation, for example. The base layer 504 can have a reduced thickness proximal to one of a heating beam portion 519 through which the heating beam can be directed, and a sensor beam portion 516 through which the sensor beam 512 from the sensor 514 can be directed. The radiation source 508 can be aligned to the panel 500 to direct the heating beam substantially normal to the inner surface of the panel. This can be via the prism 506, or in embodiments with no prism, it can be aligned normal to outer surface 520.

FIG. 5B shows that the radiation source 508 can be directed towards a first surface 524 of the panel 500. In the example, the first surface 524 can be partially defined by the base layer 504 and by the inner layer 510. The base layer 504 can extend over a recess 522. A recess 522 can be defined as a cylindrical shape or any other desired shape within the panel 500, and can be sized to receive the sensor 514. The radiation sources 508 can be directed at an angle α away from the surface of the base layer 504. The angle α may be larger than 0 degrees and smaller than 180 degrees, such as having an angle with the surface of the base layer 504 of 0 degrees up to 90 degrees, i.e. perpendicular. The angle between a surface of the base layer 504 and the heating beam 518 can be between more than 0 degrees and 50 degrees, or from 10 degrees to 30 degrees, or from 40 degrees to less than 90 degrees. The angle α in FIG. 3A may be around 40 to 50 degrees. Each radiation source 508 can be angled towards the base layer 504 at a different angle. Aligning all radiation sources 508 at the same angle is also possible.

Several devices, including the radiation source 508 may be integrated in one or more structures or modules. The radiation source may be positioned neighboring to the other device. Furthermore, two or more radiation sources may be positioned close to the other device, for instance on opposite sides of the other device, or in a ring surrounding the other device. A plurality of radiation sources 508 can be distributed around the sensor 514 as a ring shape. The recess 522 of the panel 500 may also be ring shaped. A ring shape can optionally accommodate a plurality of sensors.

The panel 500 may have a pattern that can be formed with a foil with a pre-fabricated pattern made of translucent and opaque regions, and may include a peripheral opaque border at the side edges of the panel 500. In addition or alternatively, the panel 500 may have a pattern layer made up with opaque lines and/or borders, thus forming an opaque portion and a translucent or transparent portion. The base layer 504 may be corrugated with zigzag waves or any other corrugation wave. A corrugated base layer can add a 3D effect to the panel assembly. An inner surface 526 of the base layer 504 may be provided with a foil, a mirror, a screen print or any other surface enhancing layer to optimize the 3D effect. Additionally, or alternatively, the inner surface 526 may be laser marked to include color change due to chemical/molecular alteration, charring, foaming, melting, ablation, and more.

FIG. 6 illustrates wavelength absorption of several materials. The vertical axis represents the portion of the incident beam transmitted. The horizontal axis indicates the wavelength of the incident beam. The curves represent the behavior of different materials. Examples disclosed herein include a radiation source configured to produce heating energy in the form of a beam having a heating wavelength within the heating wavelength band (A) of the thermoplastic material, through the thickness of the panel through the base layer to the outer layer to heat the outer layer at a rate that can be higher than a rate the base layer can be heated by the heating energy. An exemplary band A is illustrated, but the present subject matter is not so limited.

FIG. 7 illustrates a system including a controller, according to several examples. A panel 700 can include a system 702. The system can include a controller 704. The controller can be a pre-programmed controller including information used to control other portions of the system 702.

The system can include a driving assistance sensor 706. The driving assistance sensor can be a lidar, radar or another sensor. The controller 704 can control the sensor 706. The driving assistance sensor may have its own controller, and via an application programming interface or API or some other software platform the controller 704 can interface with the driver assistance sensor 706, such as to control whether the sensor operates, or how the sensor operates, such as by controlling signal intensity or to what extent a signal can be aimed or focused.

The system 702 can include a radiation source 708. The radiation source can be an IR beam emitter, a LASER or some other device to generate heating energy. The radiation source can be selected to provide one or more wavelengths that are absorbed by the panel materials, or by absorbers or emitters disposed in materials of the panel. If the operation of the radiation source 708 has the potential to interfere with the operation of the driving assistance sensor 706, such as by producing electromagnetic interference that can be incompatible with a signal of the driving assistance sensor 706, the controller can control the driving assistance sensor 706 and the radiation source 708 to operate at different times. These can be long periods during which one can be on and one can be off, or they can be short periods. In an example, the lidar broadcasts a beam for a short time, and then pauses for a short time, as part of a repeating pattern used to sense over time. In such an example, it is possible to activate the radiation source 708 during the pause to provide heating energy while the driving assistance sensor 706 is not transceiving information.

The system 702 can include a signal fidelity sensor 712. The signal fidelity sensor 712 can sense fidelity of a signal passing through the panel 700, which the controller 704 can correlate with one or both of panel damage or the presence of foreign material. The signal fidelity sensor 712 can determine whether damage has occurred to the panel 700, such as by projecting light through the panel and monitoring signal loss. In some examples, the driving assistance sensor 706 can perform this function. For example, when new, the driving assistance sensor can perform a baseline test to establish which portion of a sensing signal it generates passes through the panel, and over time at vehicle startup it can perform a comparison to assess whether signal fidelity has degraded versus the baseline assessment. The controller can be preprogramed with a variety of patterns associated with damage or the presence of foreign material, and can generate a vehicle signal 720 indicating the state of the panel assembly, such as by indicating to a driver that they should clear foreign material from the vehicle. The controller can monitor the change in signal fidelity over time and assess whether the degradation in signal fidelity can be due to abrasion or the presence of foreign material such as dust or ice.

A status sensor 716 can additionally provide information about the state of the panel 700, such as a temperature of the panel proximal to the driving assistance sensor 706 and/or the radiation source 708. The controller can use pre-programmed information to assess whether the radiation source 708 can effectively clear foreign material from the panel 700. A signal 720 may indicate to the driver that heating is underway, and the driver may thus choose to wait for the heating to conclude before embarking on a journey.

The system can include a foreign material sensor 710. While foreign material sensing can be performed by the signal fidelity sensor, it is possible another sensing mode may be used specifically to sense foreign material. The foreign material sensor, for example, can use vibration information to assess the state of the panel 700.

An indicator 714 can indicate a state of the panel 700. The indicator, for example, can be lamp. The lamp can provide a visual indicator of a state of the panel 700. For example, a visual indicator can illuminate a red circle proximal to a driving assistance sensor 706 to indicate that the sensor is experiencing an undesirable degradation of signal fidelity, and that the system 702 is attempting to improve signal fidelity, through heating or via some other process such as powering an ultrasonic device to excite the panel 700 to remove foreign material such as water.

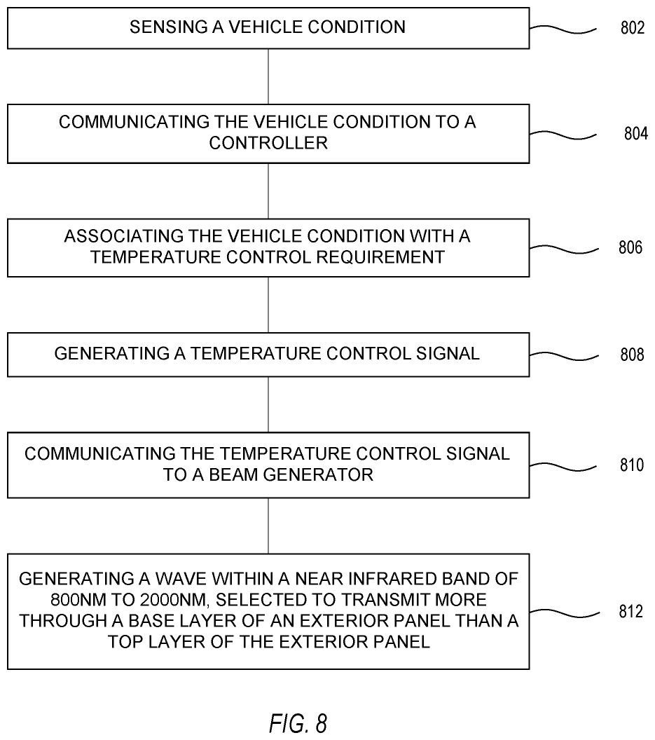

FIG. 8 illustrates a method of controlling the temperature of a panel, according to some examples. The method can include sensing a vehicle condition 802. The method can include communicating the vehicle condition to a controller 804. The method can include associating the vehicle condition with a temperature control requirement 806. The method can include generating a temperature control signal 808. The signal can be based on the temperature control requirement. The method can include communicating the temperature control signal to a beam generator 810. The method can include generating a beam within a near infrared band of 800 nm to 2000 nm. Beam generation can be in association with the control signal. The beam can be selected to transmit through a base layer of the panel at a transmission rate of one or more of the group comprising: equal to or greater than 40% when the base layer thickness can be 3 mm; equal to or greater than 50% when the base layer thickness can be 2 mm; and equal to or greater than 60% when the base layer thickness can be 1 mm; and wherein the beam can be also selected to transmit through an outer layer formed onto the base layer, at a transmission rate of one or more of the group comprising: equal to or less than 60% when the base layer thickness can be 4.0 mm; and equal to or less than 50% when the base layer thickness can be 5.4 mm.

A method can include forming an emitting layer, for example, of the device of any one of the preceding examples, including injection molding a host material composition comprising the host material into a mold to form the non-emitting region; after a first amount of time, injection molding an emitting agent composition while simultaneously injection molding the host material composition into the mold for a second amount of time to form the emitting region; wherein the emitting agent composition can includes at least one of a luminescent agent or an absorber and optionally can includes an adhesion promoter; and after the second amount of time, ceasing the injection molding of the emitting agent composition. Thereafter, the injection molding of the host material composition can cease.

The present detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The present detailed description is, therefore, not to be taken in a limiting sense, and the scope is defined only by the appended claims, along with the full scope of legal equivalents to which such claims are entitled.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. A panel for a vehicle, the panel for transmitting a sensor beam having a sensing wavelength and absorbing a heating beam having a heating wavelength, the panel comprising:
a base layer defining a base inner major surface and a base outer major surface, the base layer formed of a base layer polymer selected to transmit a heating wavelength band (Δ) within a near infrared band 800 nm to 2000 nm at a transmission rate of one or more of the group comprising:
equal to or greater than 40% when the base layer thickness is 3 mm;
equal to or greater than 50% when the base layer thickness is 2 mm; and
equal to or greater than 60% when the base layer thickness is 1 mm; and
an outer layer formed onto the base outer major surface of the base layer, the outer layer formed of an outer layer polymer selected to transmit the heating wavelength band (Δ) at a transmission rate of one or more of the group comprising:
equal to or less than 60% when the base layer thickness is 4.0 mm; and
equal to or less than 50% when the base layer thickness is 5.4 mm, wherein at least one of the base layer and the outer layer is at least one of lidar-transparent and radar-transparent.

2. The panel of claim 1, wherein the sensor beam is a lidar beam having a wavelength in the range of 900-910 nm or in the range of 1540-1560 nm, and the heating beam has a wavelength of one of approximately 1190-1210 nm, 1480-1500 nm and 1710-1730 nm.

3. The panel of claim 1, comprising an insert extending through and overmolded by the panel.

4. The panel of claim 3, wherein the insert is formed of a thermoplastic material that includes scattering particles.

5. The panel of claim 3, wherein the insert is substantially transparent to the sensor beam.

6. The panel of claim 5, wherein the outer layer includes a pigment that at least partially reflects visible light, or is coated by a material including a pigment that at least partially reflects visible light.

7. The panel of claim 1, wherein the outer layer polymer includes a thermoplastic material that includes absorber molecules.

8. The panel of claim 1, wherein the outer layer includes a laser-marked UV stabilizer defining a mark in the outer layer to scatter the heating beam.

9. The panel of claim 1, wherein the outer layer is formed of a silicone containing an absorber and/or of a polyurethane outer layer.

10. The panel of claim 1, wherein the outer layer is overmolded onto the base layer.

11. The panel of claim 1, wherein the outer layer is a wrap or paint.

12. The panel of claim 1, wherein the base layer has a reduced thickness proximal to one of a heating beam portion through which the heating beam is directed, and a sensor beam portion through which the sensor beam is directed.

13. The panel of claim 1, wherein the outer layer is not co-extensive with the base layer.

14. A panel system for a vehicle, comprising the panel of claim 1, and further comprising:
a radiation source coupled to the panel behind the base layer and opposite the outer layer, the radiation source comprising a heating beam emitter configured to emit heating energy having a heating wavelength within the heating wavelength band (Δ) of the thermoplastic material, through the thickness of the panel through the base layer to the outer layer to heat the outer layer at a rate that is higher than a rate the base layer is heated by the heating energy.

15. The panel system of claim 14, comprising a lidar emitter coupled to the panel opposite the outer layer, the lidar emitter configured to emit lidar energy through the thickness of the panel through the base layer to the outer layer.

16. A panel for a vehicle comprising:
a controller comprising information used to control other portions of the panel,
a driving assistance sensor,
a radiation source to provide one or more wavelengths that are absorbed by panel materials, or by absorbers or emitters disposed in materials of the panel,
a signal fidelity sensor to sense fidelity of a signal passing through the panel and determine whether damage has occurred to the panel,
a status sensor to provide information about a state of panel,
a foreign material sensor,
an indicator to indicate a state of the panel.

17. A method of controlling a temperature of a panel comprising:
sensing a vehicle condition;
communicating the vehicle condition to a controller;
associating the vehicle condition with a temperature control requirement;
generating a temperature control signal;
communicating the temperature control signal to a beam generator; and
generating a beam within a near infrared band of 800 nm to 2000 nm.

18. The method of claim 17, wherein the signal is based on the temperature control requirement and generation of the beam is in association with the control signal.

19. The method of claim 18, wherein the beam transmits through a base layer of the panel at a transmission rate of one or more of:
equal to or greater than 40% when the base layer thickness is 3 mm;
equal to or greater than 50% when the base layer thickness is 2 mm; and
equal to or greater than 60% when the base layer thickness is 1 mm.

20. The method of claim 19, wherein the beam transmits through an outer layer formed onto the base layer, at a transmission rate of one or more of:
equal to or less than 60% when the base layer thickness is 4.0 mm; and
equal to or less than 50% when the base layer thickness is 5.4 mm.
